(19) United States
(12) Patent Application Publication
(10) Pub. No.: US 2011/0226190 A1
(43) Pub. Date: Sep. 22, 2011

(54) PET CRATE READILY CONVERTIBLE TO VARIOUS THEMED APPEARANCES

(76) Inventor: Matthew Lamontagne, St. Clair, MI (US)

(21) Appl. No.: 13/052,434

(22) Filed: Mar. 21, 2011

Related U.S. Application Data
(60) Provisional application No. 61/315,412, filed on Mar. 19, 2010.

(51) Int. Cl. A01K 1/00

(52) U.S. Cl. 119/482

(57) ABSTRACT

A pet crate in which cover panels having themed graphics and/or contours may be readily installed over mesh panels on the sides and on the front end of the crate. The front panel has legs which extend on either side of a door and an upper portion projecting above the crate 10 creating a tower appearance.

### CROSS REFERENCES TO RELATED APPLICATIONS

This application claims the benefit of U.S. provisional patent application Ser. No. 61/315,412 filed on Mar. 19, 2010, which is incorporated by reference herein.

### BACKGROUND OF THE INVENTION

This invention concerns confinement crates or cages for pets such as dogs and cats. Such crates are usually constructed from walls of heavy gauge wire mesh to allow viewing of the confined pet and enabling the pet to look out and also insuring free air flow. Such crates are usually of a strictly utilitarian design, although crates and dog houses have sometimes been designed to have a themed appearance, such as in U.S. D557,965; U.S. D 609,407; U.S. D608,057; U.S. D561,951; U.S. D194,783 and U.S. D307,955.

It is an object of the present invention to provide a crate with an enhanced ability to provide various themed appearances and which are readily converted to a more enclosed condition.

### SUMMARY OF THE INVENTION

The above object and other objects which will become apparent upon a reading of the following specification and claims is achieved by a generally rectangular crate having two sides, a front and a rear and a top and also including an openable front door panel, of open mesh panel construction in which the various sides. The crate mesh panels are held in open frames, two side frames slotted to be able to receive two replaceable side themed panels and a front replaceable themed panel which accommodates the opening of the door and has a top portion projecting well above the crate. The two side panels each may have window openings of much reduced size from the mesh side panel which also has imprinted graphics relating to a particular theme.

The front themed panel has two spaced apart narrow leg sections slidable into recesses on either side of the door panel with the upper portion projecting substantially above the height of the crate, and contoured to create a themed appearance consistent with the graphics of the side panels.

Each of the themed panels are easily removed and alternatively themed panels installed therein.

### DESCRIPTION OF THE DRAWINGS

FIG. 1 is a pictorial view of pet crate having themed panels installed on the crate, a side panel shown only partially installed and broken away.

FIG. 1A is a fragmentary pictorial view from the rear of the pet crate shown in FIG. 1.

FIGS. 2A, 2B and 2C are reduced size frontal views of the themed panels shown on the crate in FIG. 1.

FIG. 3 is an enlarged fragmentary pictorial view of the upper front portion of the crate shown in FIG. 1 with adjacent fragmentary portions of the themed panels aligned with receiving slots formed in frame members making up the crate.

FIG. 4 is an enlarged fragmentary pictorial view of a lower front portion of the crate shown in FIG. 1 with a removable floor pan partially withdrawn.

FIG. 5 is a lengthwise fragmentary view of a section taken across the top of the crate shown in FIG. 1 with the themed decorative panels installed.

FIG. 6 is a lengthwise fragmentary view of a section taken across the bottom of the crate shown in FIG. 1.

FIGS. 7-9 are simplified reduced sized pictorial views of the crate shown in FIG. 1 in which various alternate theme panels have been installed.

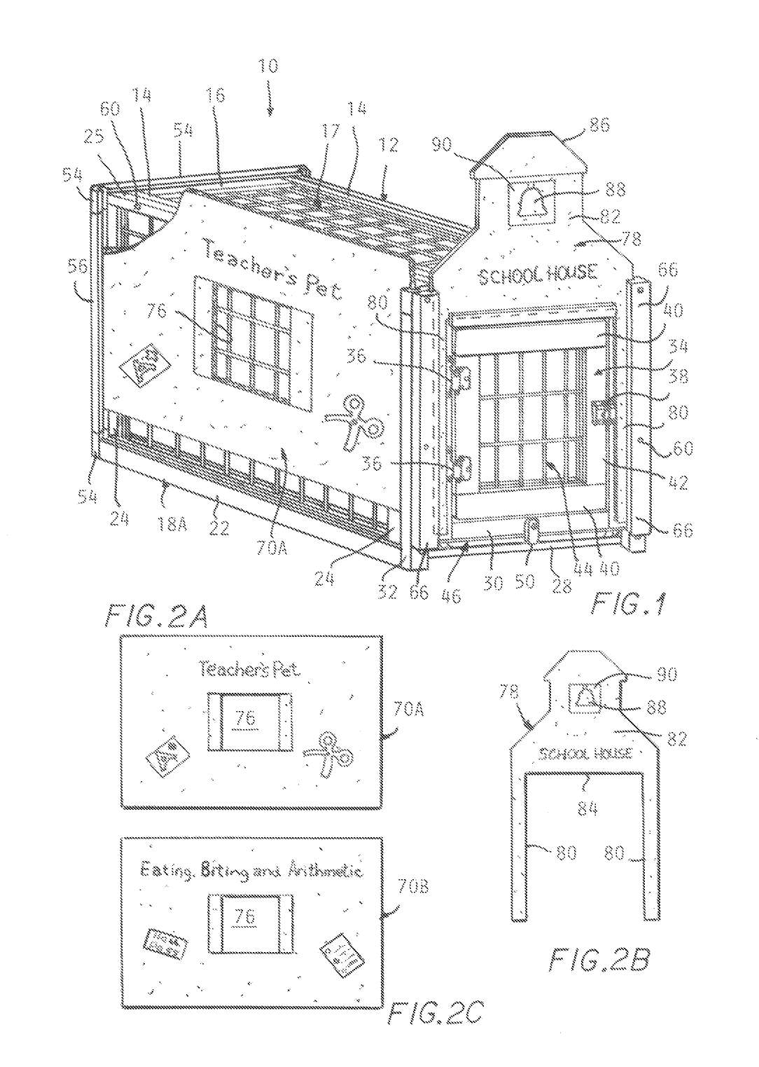

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to the drawings, a pet crate 10 according to the present invention is shown, comprised of an assembly of rectangular open frames, including a top frame 12, having side members 14, and parallel front and rear frame members 16 (FIG. 3). The inside edged of the members 14 and 16 are slotted to be able to receive a side of a rectangular top wire mesh panel 17.

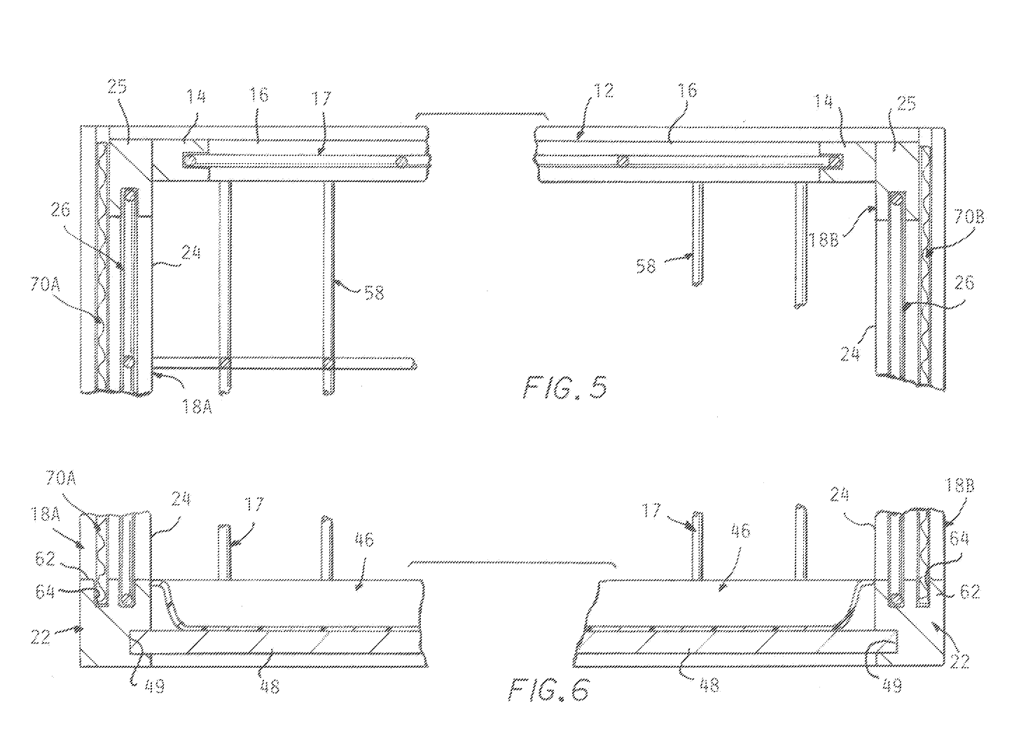

A pair of slotted side frames 18A, 18B (FIGS. 5, 6) are formed by respective vertical rear members 24 and front vertical members 20 together with the top rail members 25, and bottom rail members 22. The slotted side frames 18A, 18B receive and hold rectangular side wire mesh panels 26 in each rectangular opening of the side frames 18A, 18B (FIGS. 5, 6).

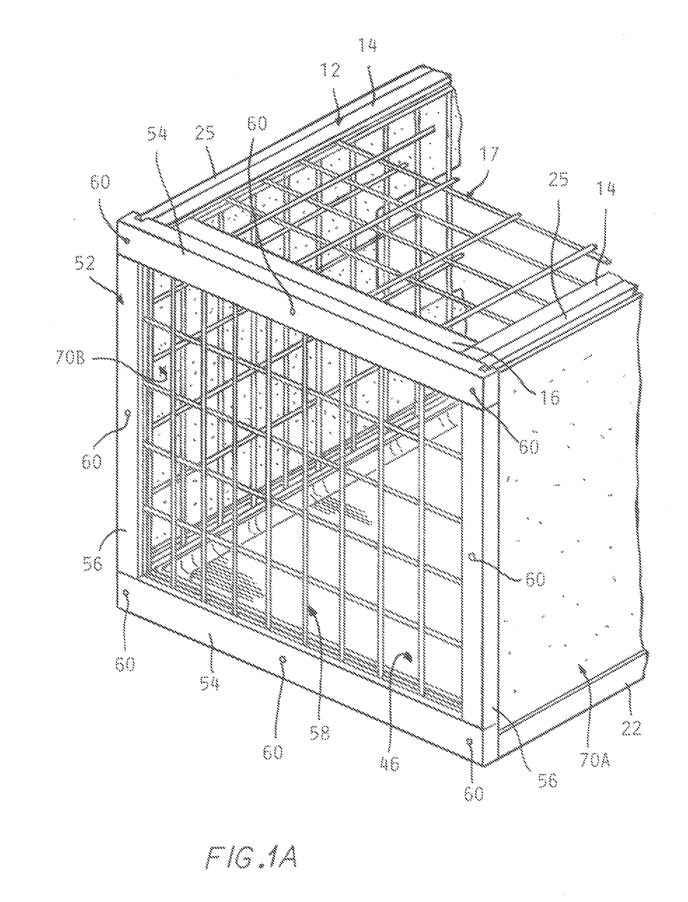

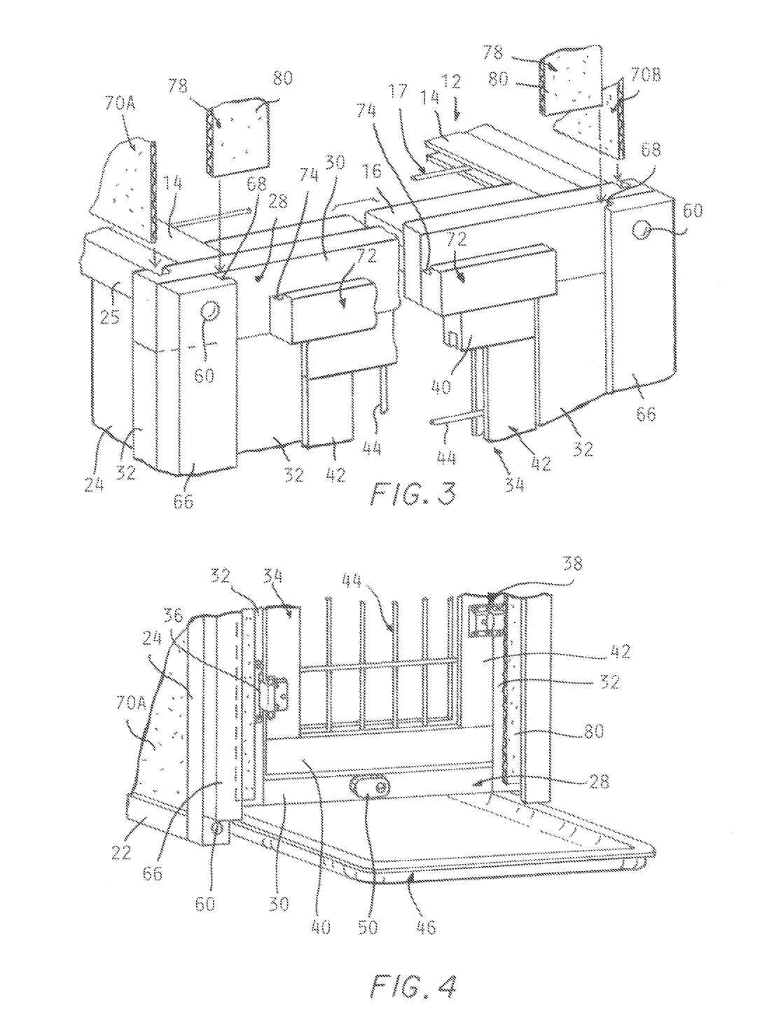

A front frame 28 is formed by top and bottom cross members 30 and vertical side members 32 (FIGS. 3 and 4) to define a rectangular opening which receives a door frame 34, hinged to left hand member 32 by a pair of hinges 36. A latch 38 releasably holds the door frame 34 closed. The door frame 34 also defines a rectangular open frame comprised of cross members 40 and vertical members 42, slotted to receive and capture a door wire mesh panel 44.

A removable plastic floor pan 46 rests on a floor panel 48 (FIG. 6) having sides received in slots 49 in the side rails 22. A swivel stop 50 prevents the pan 46 from sliding out when in a down position shown in FIG. 1.

As seen in FIG. 1A, a rear frame 52 is formed by top and bottom cross members 54 and vertical members 56 slotted to receive a rear wire mesh panel 58.

The open rectangular 12 side frames 18A, 18B, front frame 28 and rear frame 52 are secured to each other with threaded fasteners 60 preferably having decorative covers.

Thus, a box shaped crate enclosure is formed, open on the top and all sides as in conventional pet crates.

According to the present invention, a system for allowing easy installation of themed side panels 70A, 70B are provided covering the sides and a front panel is mounted to the front of the crate 10.

This system includes a projecting outer portion 62 of the bottom rails 22 each having a slot 64 cut therein (FIG. 6); outwardly projecting slotted portions of the vertical members 32, 56, and ends of the cross members 54, 30, each slotted to align with the slots in the vertical members 32, 56.

This allows insertion and capture therein of rectangular themed side panels 70A, 70B covering each side of the crate 10 and retained on three sides. The side panels 70A, 70B may be durable plastic corrugated sheets, covering a respective side of the crate 10 as seen in FIGS. 1, 1A, 3, 5 and 6. A rectangular window opening 76 is formed in each side panel 70A, 70B. Various designs and slogans are imprinted in the panel according to a theme, i.e. the school then shown.

At the front, an elongated member 66 is affixed to each vertical member 32 and a respective end of a cross piece 30 as seen in FIGS. 3 and 4. A rabbet 68 is formed on the inside edge of each piece 66.

A cross piece 72 is glued to the member 30 immediately above the door 34 having a rabbet 74 across the top edge.

A U-shaped front panel 78 has a pair of narrow legs 80 which fit into the rabbets 68, covering the space between the pieces 30 and the outer edge of the door 34. An upper portion 82 projects above the front of the crate 10, shaped to suggest a tower such as the bell tower shown. A lower edge 84 of the upper portion 82 extending between the legs 80 is received into the rabbet 74 to be held therein. The upper portion 82 projects upwardly well above the top of the crate 10 to contribute to the overall themed appearances and text and/or designs can be imprinted thereon as shown.

A roof shape 86 and bell depicted 88 in a drawing of a window 90 suggesting a school house can be provided.

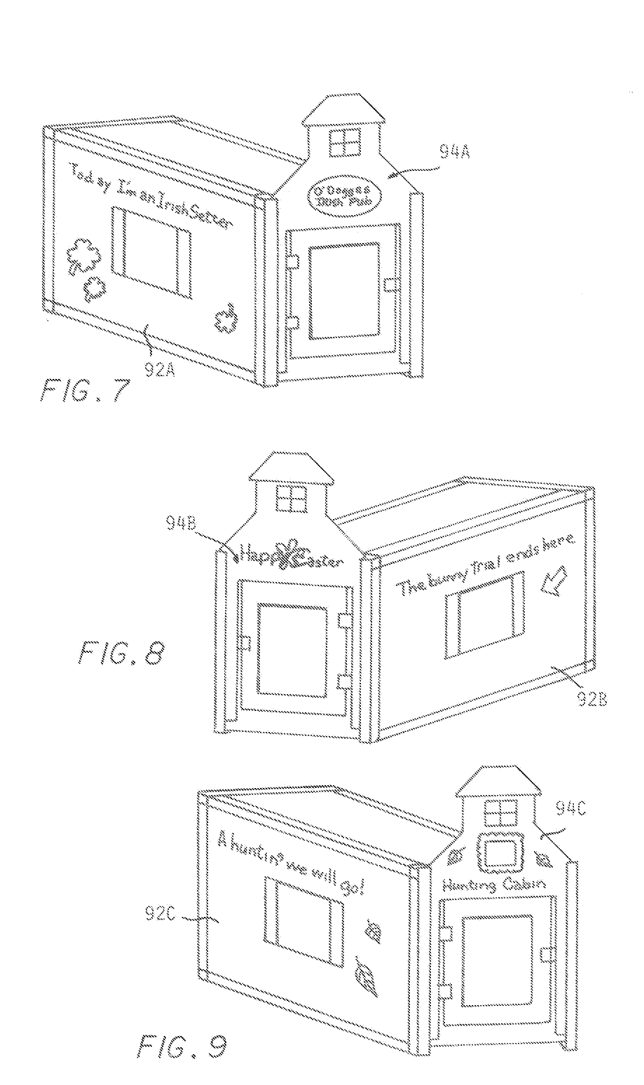

FIGS. 7-9 show other themed side panels 92A, 92B, 92C and themed front panels 94A, B, C. Sport team logos, etc., can be used as well.

Thus the panels 92, 94 can be quickly removed to allow full view and ventilation, or temporarily put in place for a special occasion.

1. A pet crate comprising a box shaped enclosure having wire mesh panels held in top, rear and two side frames and a hinged front door frame having a wire mesh panel therein mounted at a front end of said crate enabling access to the interior thereof;
a side themed panel for each side frame of said crate, imprinted with designs and/or text according to a theme; open topped slots at the front and the rear ends of each side frame slidably receiving a respective side cover panel to secure each cover panel in position overlying a respective mesh panel on each side; and
a front themed panel having a pair of side legs and a top portion, each of said legs slidable down in a rabbet on each side of said door to be held on said front side of said crate front end, with said top portion projecting well above said crate and shaped to suggest a theme.

2. The pet crate according to claim 1 wherein said top portion of said front panel is shaped as a tower.

3. The pet crate according to claim 2 wherein said decorative front panel upper portion has a downwardly angled top edge contour suggesting a sloping side roof shape.

4. The pet crate according to claim 1 wherein a window opening is provided in each side panel.

5. The pet crate according to claim 1 wherein an elongated piece rabbeted across the top is affixed to said front frame extending across the top of said door frame, and receiving a lower edge of said upper portion of said front panel, lying between said legs of said front panel.
